(19) United States
(12) Patent Application Publication
(10) Pub. No.: US 2016/0233701 A1
(43) Pub. Date: Aug. 11, 2016

(54) MULTIPLE SMARTPHONES CHARGING STATION

(71) Applicant: IOANNIS GLIATIS, ARLINGTON, VA (US)

(72) Inventor: IOANNIS GLIATIS, ARLINGTON, VA (US)

(21) Appl. No.: 14/620,134

(22) Filed: Feb. 11, 2015

(51) Int. Cl. H02J 7/00

(52) U.S. Cl. CPC H02J 7/0027; H02J 7/0045

(57) ABSTRACT

The multiple smartphones charging station includes a planar plate having a front face and a rear face. A mounting bracket is disposed on the upper portion of the rear face of the planar plate, and a charger compartment is disposed on the lower portion of the rear face. An electrical charging unit is seated within the compartment and includes charging cords extending from the compartment. A plurality of shelves extend from the front face of the planar plate. Each shelf includes a short offset bar extending substantially normal to the plate and an elongate ramp sloping upward from the offset bar. Apertures are defined in the planar plate so that the charging cords from the electrical charging unit can communicate with the smartphone on the shelf ramp. The apertures are arranged on opposing sides of each shelf

### BACKGROUND OF THE INVENTION

1. Field of the Invention

The present invention relates to battery charging stations, and particularly to a multiple smartphones charging station for charging the batteries of multiple smartphones.

2. Description of the Related Art

People today can become dependent on their smartphones, which are becoming a relatively greater part of our everyday lives. Smartphones can allow a user to make calls, send and receive emails, and take pictures, among other abilities. Thus, a charged smartphone can be a necessity for many people.

As users go about their day, a charged smartphone can be difficult to maintain. To remedy concerns about having a charged phone, some users may take a charging cord with them at all times. Further, a single cord may only charge one type of device, and the user may have more than one device that needs a charge. However, this approach can be impractical for some users. Other users may take a charging case with them. This approach can also be impractical because of the relatively bulky size of the charging case. Further, the charging case itself may need charging at some point in the future.

Bars, restaurants, coffee shops, hair and nail salons, offices, are places people visit where they may need to have a charged phone. Further, the user may have multiple electronic devices that may need charging.

There is a need for a charging station that is scalable in size and that can charge multiple smartphones all at the same time. Thus, a multiple smartphones charging station addressing the aforementioned problems is desired.

### SUMMARY OF THE INVENTION

The multiple smartphones charging station includes a planar plate having a front face and a rear face. A mounting bracket is disposed on the upper portion of the rear face of the planar plate, and a charger compartment is disposed on the lower portion of the rear face. An electrical charging unit is seated within the compartment and includes charging cords extending from the compartment. A plurality of shelves extend from the front face of the planar plate. Each shelf includes a short offset bar extending substantially normal to the plate and an elongate ramp sloping upward from the offset bar. Apertures are defined in the planar plate so that the charging cords from the electrical charging unit can communicate with the smartphone on the shelf ramp. The apertures are arranged on opposing sides of each shelf.

These and other features of the present invention will become readily apparent upon further review of the following specification and drawings.

### BRIEF DESCRIPTION OF THE DRAWINGS

FIG. 1 is a perspective view of a multiple smartphones charging station according to the present invention.

FIG. 2 is a front view of a multiple smartphones charging station according to the present invention.

FIG. 3 is a side view of a multiple smartphones charging station according to the present invention.

Similar reference characters denote corresponding features consistently throughout the attached drawings.

### DETAILED DESCRIPTION OF THE PREFERRED EMBODIMENTS

The multiple smartphones charging station is an apparatus that supports multiple cellular telephones or smartphone while charging their batteries. The multiple smartphones charging station includes a planar plate having a front face and a rear face. A mounting bracket is disposed on the upper portion of the rear face of the planar plate, and a charger compartment is disposed on the lower portion of the rear face. An electrical charging unit is seated within the compartment and includes charging cords extending from the compartment. A plurality of shelves extend from the front face of the planar plate. Each shelf includes a short offset bar extending substantially normal to the plate and an elongate ramp sloping upward from the offset bar. Apertures are defined in the planar plate so that the charging cords from the electrical charging unit can communicate with the smartphone on the shelf ramp. The apertures are arranged on opposing sides of each shelf.

The multiple smartphones charging station is scalable in size and is capable of charging multiple smart phones all at the same time. It can be constructed from durable material, such as acrylic/plexiglas, with multiple shelves to hold various electronic devices. The multiple smartphones charging station includes holes to allow for charging cables to connect from an electrical charging unit that is plugged into an electrical wall outlet. The multiple smartphones charging station can be mounted on the wall or stand on a counter.

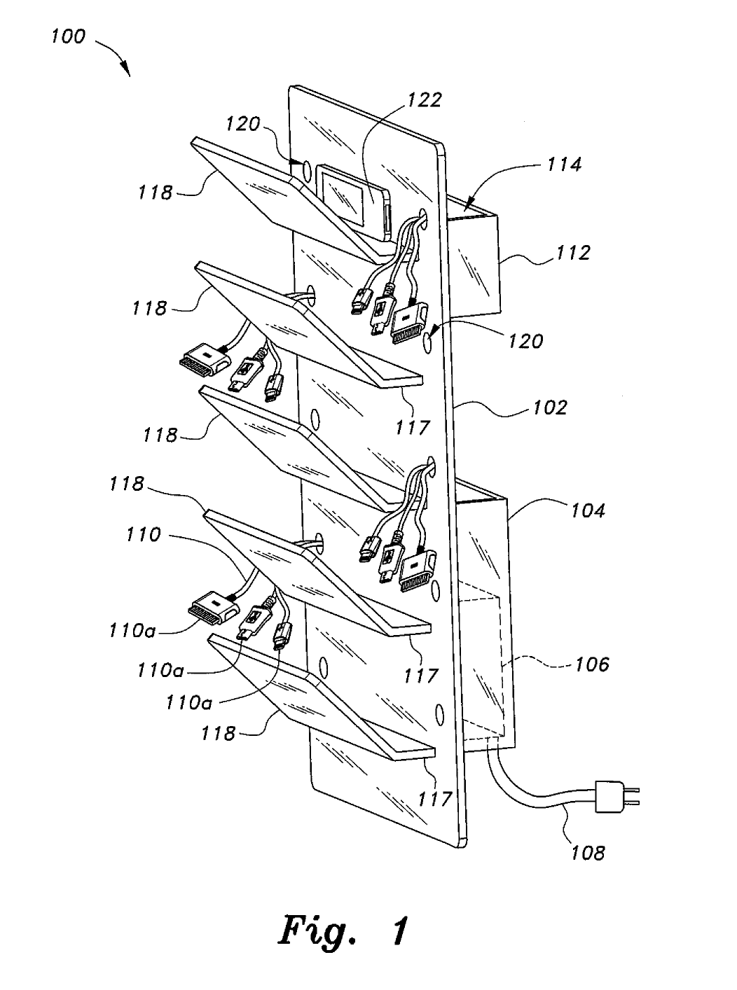

Referring to FIGS. 1-3, the multiple smartphones charging station 100 includes a planar plate 102 that has a front face and a rear face. An open top box-shaped compartment 104 is disposed on the lower portion of the rear face of the planar plate 102. An electrical charging unit 106 is seated within the compartment 104. The electrical charging unit 106 can be various power units, for example, a multi-port USB charger. Battery chargers with multiple USB ports for simultaneously charging lithium or nickel-cadmium (NICAD) battery packs are well known to those of ordinary skill in the art, are commercially available, and need not be described further. The electrical charging unit 106 includes a power cord 108 that connects to an electrical power supply, such as an electrical wall outlet.

The electrical charging unit 106 may have multiple charging cords 110 connected to and extending from the electrical charging unit 106. The multiple charging cords 110 can have various attachments 110a so that various smartphone devices 122 can be connected and charged by the charging cords 110. The multiple charging cords 110 with the multiple attachments 110a allow for multiple smartphone devices 122 to be charged all at the same time. As shown in FIGS. 1-3, the attachments 110a can be a micro USB, a 5 pin connector, or any other common connector for available phones. Alternatively, the charging unit 106 may have the USB ports mounted directly in its housing, and the user may use his own USB cable threaded through the apertures defined in the planar plate and plugged into the USB ports in the charging unit 106.

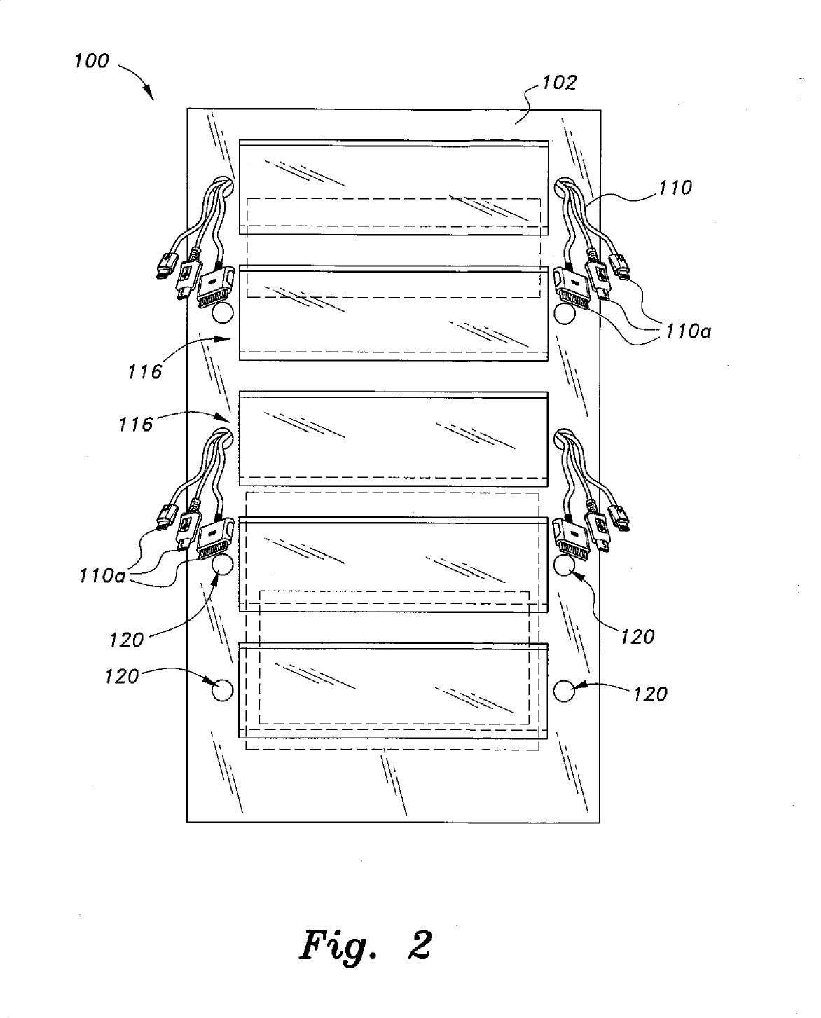

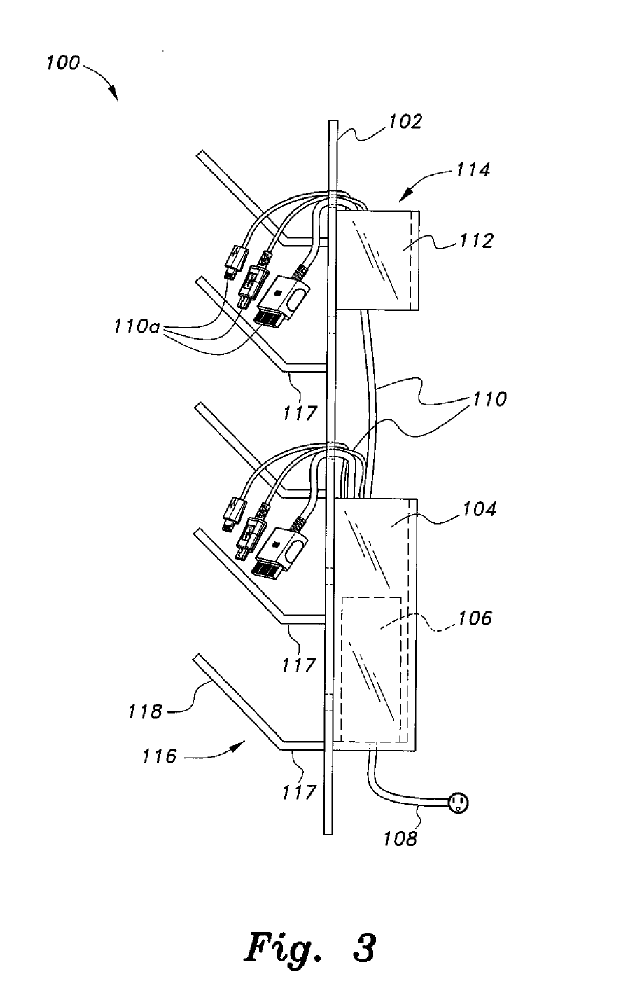

Additionally, a mounting bracket 112 is mounted on the upper portion of the rear face of the planar plate 102. The mounting bracket permits the charging station 100 to be mounted on a wall or other vertical support, if desired. A plurality of shelves 116 extend from the front face of the planar plate 102. As shown in FIGS. 1 and 3, each shelf 116 has an elongate offset bar 117 extending substantially normal to the planar plate 102 and a ramp 118 that slopes upward away from the offset bar 117 to provide a panel or platform to support a smartphone 122 while the smartphone's battery is charging, The offset bar 117 spaces the ramp 118 from the plate 102, and the ramp 118 tilts the side of the smartphone 122 so that the user can readily see the USB port in the side of the smartphone, making it quicker and easier to attach the USB charging cable to the smartphone. The shelves 116 are spaced apart vertically on the planar plate 102. Multiple apertures 120 are defined in the planar plate 102. The apertures allow for the charging cords to extend from the electrical charging unit 106 and to connect to the smartphone device 122 positioned with the rack 116. The apertures can be circular or any other shape that allows for the charging cords 110 to pass through the planar plate 102. As shown in FIG. 2, the apertures 120 may include at least one aperture disposed above each shelf 116 and arranged laterally on opposite sides of each shelf 116.

Additionally, the multiple smartphones charging station 100 can be mounted onto a wall or can be stood up against a counter top to allow for accessibility. Also, the multiple smartphones charging station 100 can be used to charge other electronic devices, such as tablets. Further, the multiple smartphones charging station 100 can be made in various shapes and sizes, as desired. For example, the planar plate 102 can have a curvilinear shape, a rectangular shape, or other geometric shapes. The planar plate 102 may, for example, have the profile of a beverage bottle or other ornamental design to match the decor of the establishment where the charging station 100 is to be used.

It is to be understood that the present invention is not limited to the embodiments described above, but encompasses any and all embodiments within the scope of the following claims.

I claim:

1. A multiple smartphones charging station, comprising:
a planar plate having an upper portion, a lower portion, a front face and a rear face;
a box-shaped compartment mounted on the rear face of the planar plate;
an electrical charging unit disposed in the compartment, the charging unit being capable of charging multiple smartphones simultaneously;
a mounting bracket disposed on the rear face of the planar plate; and
a plurality of shelves extending from the front face of the planar plate, each of the shelves having an offset bar extending substantially normal to the planar plate and a ramp sloping upward away from the offset bar, the ramp defining a platform adapted for supporting a smartphone while the smartphone is charging, the shelves being spaced apart vertically, the planar plate having at least one aperture defined therein above each of the shelves for routing a charging cable from the ramp through the planar plate for connection to the charging unit;
whereby multiple smartphones may be supported on the shelves while being charged simultaneously by the common electrical charging unit.

2. The multiple smartphones charging station according to claim 1, wherein the box-shaped compartment has an open top.

3. The multiple smartphones charging station according to claim 1, wherein the electrical charging unit comprises a multiple USB port charging station.

4. The multiple smartphones charging station according to claim 1, wherein the planar plate, the compartment, the mounting bracket, and the shelves are made from an acrylic material.

5. The multiple smartphones charging station according to claim 1, wherein the offset bars space the ramps from said planar plate.

6. The multiple smartphones charging station according to claim 1, wherein said ramps are configured for supporting the smartphones at an angle adapted for exposing a charging port on a side of the smartphones to a user, thereby facilitating connection of the charging cables to the smartphones.

7. The multiple smartphones charging station according to claim 1, wherein said mounting bracket is mounted on the upper portion of the rear face of said planar plate, whereby the charging station may be suspended from a wall.

8. The multiple smartphones charging station according to claim 1, wherein said compartment is mounted on the lower portion of said planar plate, whereby the charging station may be supported on a horizontal surface.

9. A multiple smartphones charging station, comprising:
a planar plate having a front face and a rear face, the planar plate being made from an acrylic material;
a compartment mounted on the rear face of the planar plate, the compartment being made from an acrylic material;
a multi-port USB charging station disposed in the compartment;
a mounting bracket mounted on the rear face of the planar plate, the mounting bracket being made from an acrylic material; and
a plurality of shelves extending from the front face of the planar plate, each of the shelves having an offset bar extending substantially normal to the planar plate and a ramp sloping upward away from the offset bar, the ramp defining a platform adapted for supporting a smartphone while the smartphone is charging, the shelves being spaced apart vertically, the planar plate having at least one aperture defined therein above each of the shelves for routing a charging cable from the ramp through the planar plate for connection to the charging unit;
whereby multiple smartphones may be supported on the shelves while being charged simultaneously by the common multi-port USB charging station.
